(19) United States
(12) Patent Application Publication
(10) Pub. No.: US 2018/0056607 A1
(43) Pub. Date: Mar. 1, 2018

(54) PRINTING THREE DIMENSIONAL OBJECTS USING PERFORATED BRIMS

(71) Applicant: Microsoft Technology Licensing, LLC, Redmond, WA (US)

(72) Inventor: John Socha-Leialoha, Bellevue, WA (US)

(73) Assignee: Microsoft Technology Licensing, LLC, Redmond, WA (US)

(21) Appl. No.: 15/251,656

(22) Filed: Aug. 30, 2016

(51) Int. Cl. B29C 67/00; B33Y 50/02; B33Y 30/00; B33Y 10/00; G05B 19/4099

(52) U.S. Cl. CPC B29C 67/0092; B33Y 50/02; B33Y 30/00; G05B 2219/49019; B29C 67/0088; G05B 19/4099; B33Y 10/00

(57) ABSTRACT

An example system for printing three-dimensional (3D) objects includes a computer processor and a computer memory including instructions that cause the computer processor to receive a 3D model of a 3D object to be printed. The computer memory also includes instructions that cause the computer processor to generate a perforated brim model of a perforated brim object to be printed based on the 3D model. The perforated brim model includes a perforation pattern. The computer memory also further includes instructions that cause the computer processor to cause a 3D printer to print the perforated brim object and the 3D object. The perforation pattern of the perforated brim object is to be coupled to the 3D object.

### BACKGROUND

Three-dimensional (3D) objects may be printed via three-dimensional printing devices (3D printers) using rafts or brims for bed adhesion. For example, the rafts or brims may help stabilize small parts during printing by keeping them connected to the print bed. Rafts or brims may also help prevent portions of 3D-printed objects from curling away from the print bed due to uneven cooling or any other reason.

### SUMMARY

The following presents a simplified summary of the innovation in order to provide a basic understanding of some aspects described herein. This summary is not an extensive overview of the claimed subject matter. It is intended to neither identify key elements of the claimed subject matter nor delineate the scope of the claimed subject matter. Its sole purpose is to present some concepts of the claimed subject matter in a simplified form as a prelude to the more detailed description that is presented later.

An implementation provides a system for printing 3D objects. The system includes a computer processor and a computer memory. The computer memory includes instructions that cause the computer processor to receive a 3D model of a 3D object to be printed. The computer memory includes instructions that cause the computer processor to generate a perforated brim model of a perforated brim object to be printed based on the 3D model. The perforated brim model includes a perforation pattern. The computer memory includes instructions that cause the computer processor to cause a 3D printer to print the perforated brim and the 3D object. The perforation pattern of the perforated brim object is to be coupled to the 3D object.

Another implementation provides a method for printing three-dimensional (3D) objects coupled to a perforated brim. The method includes receiving a 3D model of a 3D object. The method also includes generating a perforated brim model based on the 3D model. The perforated brim model includes a perforation pattern disposed on an inner perimeter of a first brim layer of the perforated brim model. The perforation pattern is configured to be in intermittent contact with an outer perimeter of the 3D model. The method also includes generating instructions for a 3D printer to print the 3D object with a perforated brim object based on the 3D model and the perforated brim model.

Another implementation provides one or more computer-readable storage medium for storing computer readable instructions that, when executed by one or more processing devices, instruct the generation of a perforated brim model based on a three-dimensional (3D) model of a 3D object. The computer-readable medium includes instructions to receive a 3D model of a 3D object to be printed. The computer-readable medium also include instructions to generate a perforated brim model of a perforated brim object based on the 3D model. A first brim layer of the perforated brim model includes a perforation pattern. The perforated brim model is to be printed coupled to the 3D-printed object.

Another implementation provides a method for generating a perforated brim model for a 3D model. The method includes calculating a distance from a center of a first layer to an outer perimeter of the first layer of a 3D model of a 3D object. The method also includes detecting a printing material to be used to print the 3D object. The method also includes calculating a brim contact ratio based on the calculated distance, or the detected printing material. The method further includes generating a brim perforation pattern. The brim perforation pattern is disposed on an inner portion of the perforated brim model, and intermittently contacts the outer perimeter of the 3D model based on the calculated brim contact ratio.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of an example 3D printer for fabricating a 3D object from a 3D model;

FIG. 2A shows a top down view of an example perforated brim to 3D object coupling with a lower brim contact ratio;

FIG. 2B shows a top down view of an example perforated brim to 3D object coupling with a higher brim contact ratio;

FIG. 3 shows a perspective view of an example perforated brim coupled to a 3D object;

FIG. 4 shows a close-up view of an example perforated brim coupled to a 3D object;

FIG. 5 shows a close-up view of an example first layer of a perforated brim coupled to a 3D object;

FIG. 6 shows a cross section view of an example perforated brim coupled to a 3D object;

FIG. 7 shows a cross section view of an example perforated brim including a half height perimeter;

FIG. 8 shows a close-up top down view of an example first layer of a perforated brim coupled to the first layer of a 3D object;

FIG. 9 shows a close-up top down view of an example second layer of a perforated brim and a second layer of a coupled 3D object;

FIG. 10 shows a process flow diagram of an example method for printing 3D objects coupled to a perforated brim;

FIG. 11 shows a process flow diagram of an example method for generating a perforated brim model for a 3D model;

FIG. 12 is a block diagram of an example operating environment configured for implementing various aspects of the techniques described herein;

FIG. 13 is a block diagram of an example computer-readable storage medium that can be used to generate a perforated brim model based on a three-dimensional (3D) model of a 3D object; and

FIG. 14 is a block diagram of an example system 1200 including a computing device in communication with a three-dimensional (3D) printer capable of or configured to print a 3D object with a perforated brim.

### DETAILED DESCRIPTION

As discussed above, the 3D printing process can result in part of a 3D-printed object curling and consequently losing adhesion to the platform surface. The first layer of a 3D printed object can often determine the success or failure for the entire print. Detachment of the first layer from the platform surface may cause print failures due to part or all of the 3D-printed object (hereinafter referred to as 3D object) detaching from the build plate, or a first layer of the 3D object becoming curved instead of flat. This may especially be an issue with narrow or small features of a 3D object. Techniques including the use of rafts and brims can be used to hold the 3D object to the platform surface, however rafts and brims can be difficult to remove. A raft, as referred to herein, is material added beneath a 3D object that may be slightly larger than the 3D object, and is designed to be removed from the 3D object. Rafts may be very difficult to remove, often requiring tools to cut and/or scrape the material away. Brims are continuations of the outer perimeter away from the 3D object. Brims are usually torn away from the model, and often do not tear cleanly, thus leaving behind some of the material that may then be cut, filed, or sanded away.

This disclosure describes techniques to improve 3D printing using perforated brims. A perforated brim may include one or more perforations and be coupled to a perimeter of a 3D object. In some examples, the perforated brim may also include brim extension material to provide additional strength to the perforated brim. In some examples, the techniques described herein improve the efficiency of printing 3D objects. For example, the present techniques provide the ability to remove brims after printing without using any special cutting tools. The present techniques also provide the ability to balance the strength of brims with the ease of brim removal. For example, the proportion of the perforated brim in contact with the 3D object to the total length of the perforated brim may be called a brim contact ratio. In some examples, the brim contact ratio between the brim and the perimeter of the 3D object may be based on a distance from the center of the 3D object and the printing material. These techniques are described in more detail below. Thus, time and resources may be saved by ensuring that 3D objects are successfully printed using the perforated brims and allowing the perforated brims to be easily removed once the printing is completed. In addition, the techniques can be used effectively for various 3D printing technologies. For example, 3D objects printed on stereolithographic (SLA) 3D printers may be difficult to remove from the bottom of the build vat. An additional printed support structure may be used in an attempt to prevent the 3D object from tearing away from the support and remaining in the build vat. These additional support structures may be loosely attached in many places rather than in a few support places connected with a larger cross-section. Furthermore, in laser sintering 3D printing machines, sometimes 3D objects are printed using a material (e.g., metal powder) designed to be hardened in a separate process, and are very fragile until the 3D objects have been fired (sintered) at high temperature. Thus, the techniques herein may be used to provide additional support for the 3D objects to make it easier to move them without damage using a support that is easy to remove.

In some aspects, a 3D printing software application, generally referred to as a slicer or 3D print driver, which may execute on a computing device, may perform the above-described techniques for generating a perforated brim to be printed. As used herein, a slicer may refer to a software program that converts a 3D model into a collection of sliced layers, or slices, of one or more layer heights. As used herein, a slice refers to a single, typically vertical, cross-sectional layer of a 3D model or perforated brim model. The sliced layers may be viewed graphically on a display, or converted to toolpath commands used to instruct a 3D printer to create a physical manifestation of the 3D model. Slicer program functionality may be performed wholly or in part on a mobile or other personal computing device, on a computing component within a 3D printer, or on a local or remote computing environment that may include physical or virtualized computing resources (e.g., datacenter server, virtual machine).

In some cases, the slicer or other device or application may determine the perforated brim from a model of the 3D object to be printed, for example from a computer aided design (CAD) package, image data from a 3D scanner, etc., such that perforated brim generation may be performed automatically.

It should be appreciated that the described techniques may be applied to various 3D object generation techniques implementing a fixed layer approach, such as extrusion techniques including fused deposition modeling (FDM), fused filament fabrication (FFF), Robocasting or Direct Ink Writing (DIW), or other types of additive manufacturing techniques that use a slicing or layered method, such as Vat Photopolymerization, Material Jetting, Binder Jetting, Powder Bed Fusion, Directed Energy Deposition, etc.

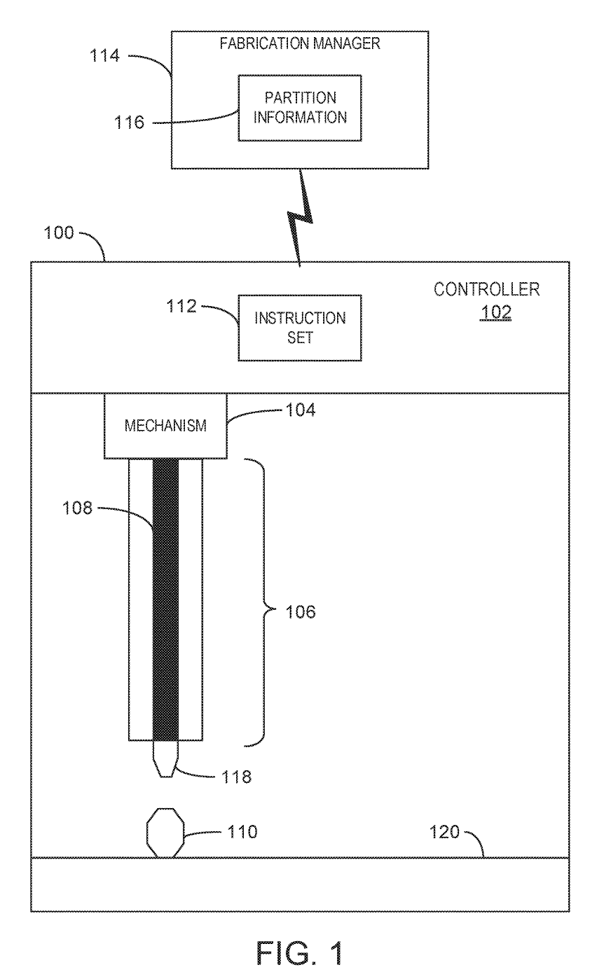

As a preliminary matter, some of the figures describe concepts in the context of one or more structural components, variously referred to as functionality, modules, features, elements, or the like. The various components shown in the figures can be implemented in any manner, such as software, hardware, firmware, or combinations thereof. In some cases, various components shown in the figures may reflect the use of corresponding components in an actual implementation. In other cases, any single component illustrated in the figures may be implemented by a number of actual components. The depiction of any two or more separate components in the figures may reflect different functions performed by a single actual component. FIG. 1, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into multiple component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, such as application specific integrated circuits (ASICs), or the like.

As to terminology, the phrase “configured to” encompasses any way that any kind of functionality can be constructed to perform an identified operation. The functionality can be configured to perform an operation using, for instance, software, hardware, firmware, or the like. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system. The term “inner perimeter” may refer to the innermost continuous edge or boundary of a brim model, a brim object, or any 3D model or object. The term “outer perimeter” may refer to the outermost continuous edge or boundary of a 3D model, a 3D object, a brim model, or a brim object. The term “perimeter” alone, may also refer to the outermost continuous edge or boundary of a 3D model, a 3D object, a brim model, or a brim object. The term “intermittent contact” may refer to contact between two or more of any type of perimeter of a model or object, that is not continuous but in contact at multiple points that may be at periodic distances or at non-periodic, varying distances between contact points. The term “brim contact ratio” may refer to the ratio of a distance of a segment of brim in contact with a perimeter divided by the distance of the segment plus the distance of an adjoining, non-contacting segment of brim.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may include communication media such as transmission media for wireless signals and the like.

FIG. 1 is a block diagram of an example 3D printer for fabricating a 3D object from a 3D model. The 3D printer 100 may include a control unit or controller 102 coupled to a first mechanism 104 and configured to execute instructions for the first mechanism 104 and a second mechanism 106. A chamber 108 constructed within the second mechanism 106 allows materials to be prepared, e.g., heated and blended, when fabricating an object 110. For example, the chamber 108 is used for melting and extruding filaments or other compatible materials.

The first mechanism 104 may be referred to as a robotic mechanism, e.g., a gantry robot, including various mechanical or electro-mechanical components such as motors, belts, guide rods, lead screws, position encoders, optical sensors, image sensors, etc. By executing at least some instructions within an instruction set 112, the first mechanism 104 may actuate these components into performing at least some physical movement. The fabrication manager 114 may generate the instruction set 112 by partitioning a 3D model into layers (slicing) and providing specific fabrication instructions for each layer. When actuated, these components of mechanism 104 may move horizontally, vertically, diagonally, rotationally, and so forth. One example implementation of the first mechanism 104 moves a printing mechanism or tool across an x, y, or z-axis in order to deposit material at instructed positions on the object 110 being fabricated.

The second mechanism 106 may be referred to as a printing mechanism that includes one or more printing tool heads. The material may be pushed or pulled into a printing tool head, and the motors may be mounted further away from the printing tool head in order to push the material through a thin guide tube into the chamber 108 wherein some materials may be melted just before exiting from nozzle 118. Many 3D printers or additive manufacturing devices print or generate 3D objects from 3D models created using computer aided design (CAD) applications, for example, by slicing the model into thin horizontal layers and depositing material (e.g., melted plastic, clay, concrete, metal powder, food stuff) vertically layer by layer. Although the second mechanism 106 may resemble an extruder configuration, e.g., a single extruder head configuration, it is appreciated that the second mechanism 106 represents any compatible technology, including legacy printing tool heads configured to deposit various types of materials.

Instructions stored in an instruction set 112 may be collectively referred to as coordinated instructions because such instructions are executed, in coordination with multiple components. For example, instructions for different stepper motors in an extruder configuration may be coordinated such that an appropriate extrudable material is fed into the chamber 108. A stepper motor may reside in mechanism 104 and control the height of a nozzle 118 relative to a platform 120 as described below. Accordingly, an instruction for one stepper motor may be synchronized in time with an instruction for another stepper motor such that both stepper motors can operate in coordination with each other.

The fabrication manager 114 may include hardware and software components operating on various implementations of computing devices, such as a remote computing device and an attached computing device. One example implementation of the fabrication manager 114 processes a 3D model corresponding to an object being fabricated and partitions that information into layers in which each layer includes at least some geometry, which may include geometric elements corresponding to a surface mesh. The present disclosure may use “partition”, “slice”, or another similar term in place of “layer,” and it is appreciated that these terms be defined as interchangeable.

Within partition information 116, the fabrication manager 114 stores a data structure corresponding to the 3D model indicating a geometry of a 3D object to be printed or rendered. Geometry generally refers to a set of geometric elements, such as a 3D polyhedron or other shape, which may represent an amount of extrudable material to be deposited. One example measure represents at least a portion of the geometry—and therefore, the amount of extrudable material—volumetrically. The example measure may define a portion of the geometry using standardized units in which each unit represents a minimal amount, e.g., volume, of colored material at a given time instance, such as by an extrusion width. Each geometric element may include one or more standardized units.

The fabrication manager 114 is configured to generate instructions that, when executed by the controller 102, actuate components of the first mechanism 104, which may result in movements of the second mechanism 106 following a surface geometry, e.g., an exterior shell of the object being printed 110. Optionally, a movable platform, such as a platform 120, functions as a mechanism for moving the object being printed 110. The first mechanism 104 may operate the platform 120 to guide the object being printed 110 and the nozzle 118 to extrude material. The instruction set 112 may include instructions for automatically calibrating the platform 120 such that through a series of movements in an x, y, and z direction or in rotation across an x-y plane, the 3D object 110 is moved to a correct position for the nozzle 118 to deposit material.

Some example implementations of the 3D printer 100 include legacy devices that are retrofitted with at least some of the components described herein, including the controller 102, the fabrication manager 114, and a printing tool head, such as the second mechanism 106. As one option, the 3D printer 100 may include an additional microprocessor to manage the set of motors located in the first mechanism 104 for guiding the nozzle 118 and to receive a signal from a microprocessor when a command is processed.

To illustrate one example, a verified manifold object, represented in a 3D mesh model, may be partitioned into layers (sliced) by processing each polygon representing the object, and projecting each polygon through a slicing plane. A manifold object can include any object with an enclosed, orientable surface area. This projection generates a point and connections to other points in a manner that eventually creates a path. From this point, the path is reduced to units, e.g., volumetric measures of geometric elements, representing addressable units for a specific hardware characteristic of a corresponding 3D printer. The units may not be the same size, consistent within each axis, or the same scale in each axis or dimension. For example, a dimension can be an x, y, or z dimension. One example implementation may utilize non-cubic units of different sizes along an x, y, or z axis, which enables different effective resolutions per dimension. According to an example implementation, the partition information 116 may include voxelized data such that each addressable (voxel) unit includes a variety of information, such as color, texture, and lighting values, for a geometry within that addressable voxel unit.

An example 3D printer 100 includes an arrangement of motors and a tool head having a mixing chamber and a nozzle. The tool head also may include a heating element for melting extrudable material to a prescribed or predetermined temperature. When fabricating the 3D object, the fabrication manager 114 determines an approximate amount of extrudable material capable of being deposited at a given (x, y, z) location. The fabrication manager 114 uses the determined amount to define addressable units on the object's shell. Each unit represents a specific geometric element or a portion of the 3D object. The addressable units may be represented herein as voxelized data, e.g., voxelized data structure. In an example implementation, the fabrication manager 114 determines volume in voxel units, e.g., volumetric pixels. The 3D printer's 3D space is factored by a minimum volume of extrudable material. Other information may include implicit values, such as, distance to an object surface mesh, or probabilities indicating whether a voxel unit of the object occupies the volume represented, and the like. This technique may be applied to the object's entire volume, including the outer shell.

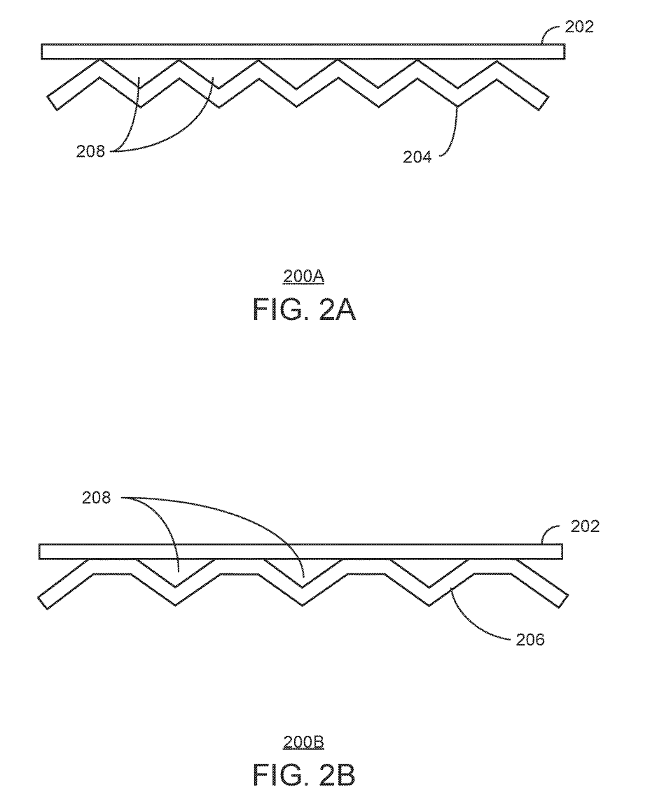

FIG. 2A shows a top down view of an example perforated brim to 3D object coupling with a lower brim contact ratio. The example perforated brim is generally referenced by the reference number 200A. The perforated brim 200A can be printed using the 3D printer 100 above.

In the example of FIG. 2A, a perforated brim 204 is shown coupled to the perimeter of a 3D object 202. The perforated brim 204 of FIG. 2A exhibits a triangular wave form pattern resulting in perforations 208. In some examples, the perforated brim 204 may include a saw-tooth pattern that is coupled to the 3D object 202 at various points resulting in perforations 208. A saw-tooth pattern, as used herein, refers to a pattern shaped like the teeth of a saw with alternate steep and gentle slopes. Alternatively, or in addition, various other shapes can be used. For example, half circles with perimeters touching the outer perimeter, as well as ellipses, rectangles, among other suitable shapes may be used. In some examples, the coupling between the 3D object 202 and the brim 204 can be described using a brim contact ratio. The brim contact ratio may be a proportion of contact between the 3D object 202 and the brim 204 to the total length of coupling between the 3D object 202 and the brim 204. For example, a brim contact ratio of one or any other suitable value or percentage may be used to describe a complete and continuous contact between the 3D object 202 and the brim 204 along a length of the coupling between the 3D object 202 and brim 204. A brim contact ratio of less than one, on the other hand, may be used to describe an incomplete contact between the 3D object 202 and the brim 204, and thus also indicates the presence of one or more perforations 208. A lower brim contact ratio therefore may be used to describe a length of brim 204 with more or larger perforations 208. In the example of FIG. 2A, the coupling 200A may thus be described as having a brim contact ratio below a threshold indicating a lower brim contact ratio.

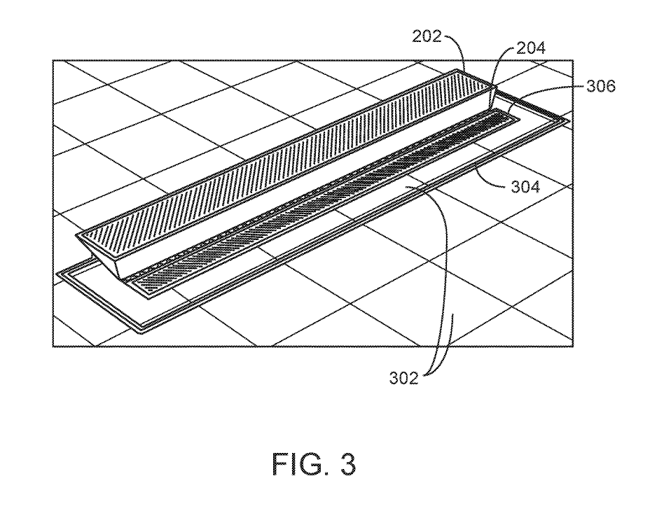

It is to be understood that the block diagram of FIG. 2A is not intended to indicate that the perforated brim 200A is to include all of the components shown in FIG. 2A. Rather, the perforated brim 200A can include fewer or additional components not illustrated in FIG. 2A (e.g., additional perforations, layers, etc.). For example, although a first layer is depicted, additional layers of material may be deposited on both the 3D object 202 and the brim 204. In some examples, the brim 204 may have a brim extension material coupled to both the top and side of the saw-tooth pattern, as discussed with respect to FIGS. 3-5 below.

FIG. 2B shows a top down view of an example perforated brim to 3D object coupling with a higher brim contact ratio. The example perforated brim is generally referenced by the reference number 200B. The perforated brim 200B can be printed using the 3D printer 100 above.

In the example of FIG. 2B, the perforated brim 206 may be described as shaped in a flattened zipper pattern. For example, the length of contact between the perimeter of the 3D object and the perforated brim 206 may be about half of the total length of the coupling 200B. Thus, the brim contact ratio of the coupling 200B may be described as having a brim contact ratio of any suitable value that indicates approximately half of the edge of a 3D object connects to the perforated brim. In some examples, a higher brim contact ratio may be used to provide more strength to hold down the 3D object 202 to a platform surface 302. For example, the brim contact ratio may be a variable brim contact ratio based on a distance from the center of the 3D object 202 to the perforated brim 206. In some examples, a higher brim contact ratio may be used for portions of a perforated brim 206 that are further away from the center of a 3D object 202. In some examples, a lower brim contact ratio may be used to make removal of the perforated brim 206 easier where added hold-down strength is not as useful. For example, portions of brim closer to the center of a 3D object may have lower brim contact ratios. In some examples, the brim contact ratio may also be based upon the printing material to be used. For example, a perforated brim 206 using more delicate printing materials may use high brim contact ratios, while a perforated brim 206 using stronger printing materials may have a lower brim contact ratio.

It is to be understood that the block diagram of FIG. 2B is not intended to indicate that the perforated brim 200B is to include all of the components shown in FIG. 2B. Rather, the perforated brim 200B can include fewer or additional components not illustrated in FIG. 2B (e.g., additional perforations, layers, etc.). For example, although a first layer is depicted, additional layers of material may be deposited on both the 3D object 202 and the perforated brim 204. In some examples, the perforated brim 206 may have additional brim extension material coupled to both the top and side of the flattened zipper pattern.

FIG. 3 shows a perspective view of an example perforated brim coupled to a 3D object. In some examples, the perforated brim and 3D object may be printed using the 3D printer 100 of FIG. 1 above.

In FIG. 3, a platform 302 has a skirt 304, a perforated brim 204 with brim extension 306, and a 3D object 202 on its surface. The skirt 304 may be used to prime the extruder of the 3D printer and establish a smooth flow of printing material prior to printing the perforated brim 204. The brim extension 306 may hold the 3D object 202 to the platform 302. For example, the brim extension 306 may be wide enough so that the 3D object 202 and perforated brim 204 stick well to the build plate. The perforated brim 204 can therefore hold down the 3D object 202 and the perforated brim 204 may be further held down by the brim extension 306. The 3D object 202 may have a bottom that is very narrow and may detach from the platform surface 302 before the print finishes. For example, the bottom of the 3D object may be less than a threshold width. For example, the threshold width may be about 1 millimeter or any other threshold width based on the material being used. In some examples, the brim extension 306 may also make removal of the brim 204 easier. For example, a wider brim extension 306 may be easier to manipulate by hand.

In the example of FIG. 3, the brim 204 is shown coupled to one side of the perimeter of the 3D object 202. The brim 204 includes an additional brim extension 306 to hold down the 3D object 202 to the platform 302. For example, the support 306 may prevent one or more portions of the 3D object 202 from lifting from the surface of the platform 302.

It is to be understood that the block diagram of FIG. 3 is not intended to indicate that the perforated brim 204 is to include all of the components shown in FIG. 3. Rather, the perforated brim 204 can include fewer or additional components not illustrated in FIG. 3 (e.g., additional perforations, layers, perforated brims, etc.). For example, although a single perforated brim 204 is shown coupled to one side of the perimeter of the 3D object 202, additional brims may be included to provide support for the other sides of the 3D object 202. In some examples, all the edges of the 3D object 202 may be supported by a perforated brim 204.

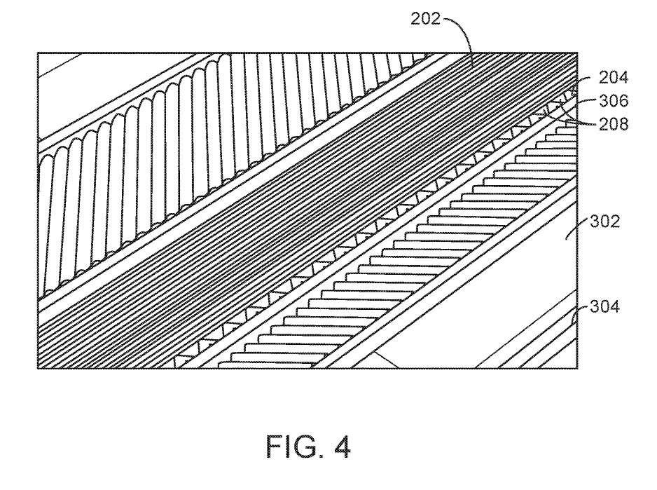

FIG. 4 shows a close-up view of an example perforated brim coupled to a 3D object. FIG. 4 includes similarly numbered elements from FIGS. 2 and 3.

In the close up view of FIG. 4, a saw-tooth pattern as in FIG. 2A above is used. Thus, the brim contact ratio of the brim 204 may be described as a low brim contact ratio. For example, the width of the perforations 206 may be greater than a threshold value. The width of the contacts between the 3D object 202 and the brim 204 may be less than a threshold value. For example, if the width of the contacts is about 0.1 millimeter, the brim contact ratio may be about 0.1 given a millimeter perforation width. The perforations 206 may be frequent enough that they will keep the part of the 3D object 202 from separating from the build plate, but also small enough that the brim is very easy to detach from the 3D object itself.

In some examples, the brim extension 306 may include a second layer that partially covers the perforated brim 204. For example, the second layer in FIG. 4 shows a second layer of straight lines over parts of the saw-tooth perforation pattern. The second layer may provide strength to ensure that the saw tooth touching the part will tear away from the part and remain with the brim. Thus, most of the perforated brim 204 may be one layer high only in close proximity to the 3D object, and more than one layer away from the 3D object, such that any tearing will be focused in the one-layer section. The resulting tear may be a cleaner tear and thus may not need any further processing.

It is to be understood that the block diagram of FIG. 4 is not intended to indicate that the perforated brim 204 is to include all of the components shown in FIG. 4. Rather, the perforated brim 204 can include fewer or additional components not illustrated in FIG. 4 (e.g., additional perforations, layers, brims, etc.).

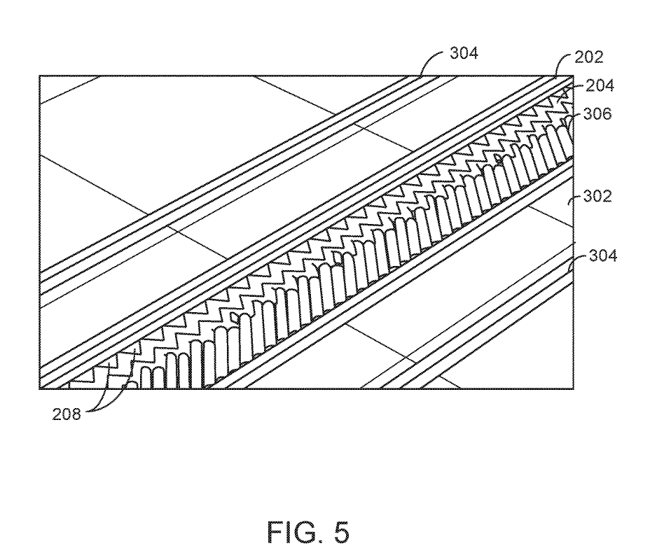

FIG. 5 shows a close-up view of an example first layer of a perforated brim coupled to a 3D object. FIG. 5 includes similarly numbered elements from FIGS. 2 and 3.

In the close up of FIG. 5, the first layers of the perforated brim 204 with brim extension 306 and the 3D model 202 are shown coupled via the saw-tooth connections. In some examples, the brim extension 306 may include a series of connected pieces to form a solid extension for the perforated brim 204 opposite the 3D object. In some examples, the brim extension 306 may be generated to be wide enough to easily grasp using fingers for easier removal of the perforated brim 204. For example, once the 3D object 202 and brim 204 is printed, a user may then lift the 3D object 202 and perforated brim 204 from the platform 302 and bend the brim 204 at the saw tooth connections. The saw tooth connections may thereby easily separate from the 3D object 202 without leaving any significant residue.

It is to be understood that the block diagram of FIG. 5 is not intended to indicate that the perforated brim 204 is to include all of the components shown in FIG. 5. Rather, the perforated brim 204 can include fewer or additional components not illustrated in FIG. 5 (e.g., additional perforations, layers, brims, etc.).

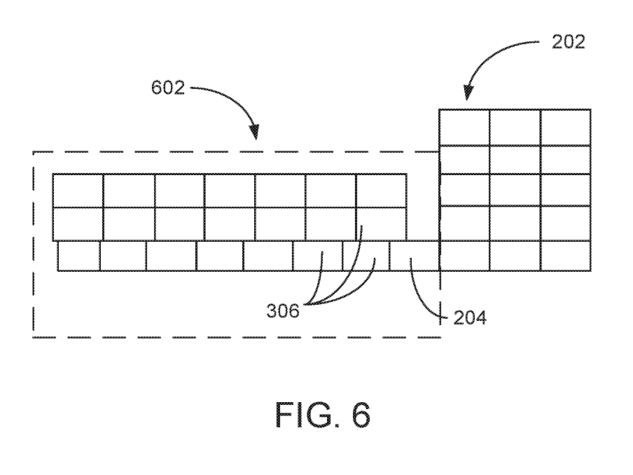

FIG. 6 shows a cross section view of an example perforated brim coupled to a 3D object. The example perforated brim is referred to generally by the reference number 602 and includes a perforated pattern 204 and additional brim extension 306 having three layers. A 3D object 202 has five layers and is coupled to the perforated brim 602 at the single layer perforated pattern 204.

As shown in FIG. 6, additional layers can be introduced to the brim extension 306 to strengthen the brim 602. In some examples, as discussed above, the brim extension may be made wider for ease of grasp. Because the 3D object 202 and the perforated brim 602 are connected by a single layer 204, less residue may be left after separating the 3D object 202 and the perforated brim 602. If the thicker brim extension layer overlaps the thinner underlying layer of the perforated brim as shown in FIG. 6, the weakest part may be the junction between the perforated brim and the 3D object. Thus, by increasing the height of the perforated brim 602 away from the 3D object 202 so that the tearing forces may be located in a small area, remnant pieces of the brim on the 3D object resulting from the tear may be reduced. Therefore, no additional tools for cutting or cleaning the 3D object 202 may be necessary.

It is to be understood that the block diagram of FIG. 6 is not intended to indicate that the perforated brim 602 is to include all of the components shown in FIG. 6. Rather, the perforated brim 602 can include fewer or additional components not illustrated in FIG. 6 (e.g., additional layers, brims, etc.).

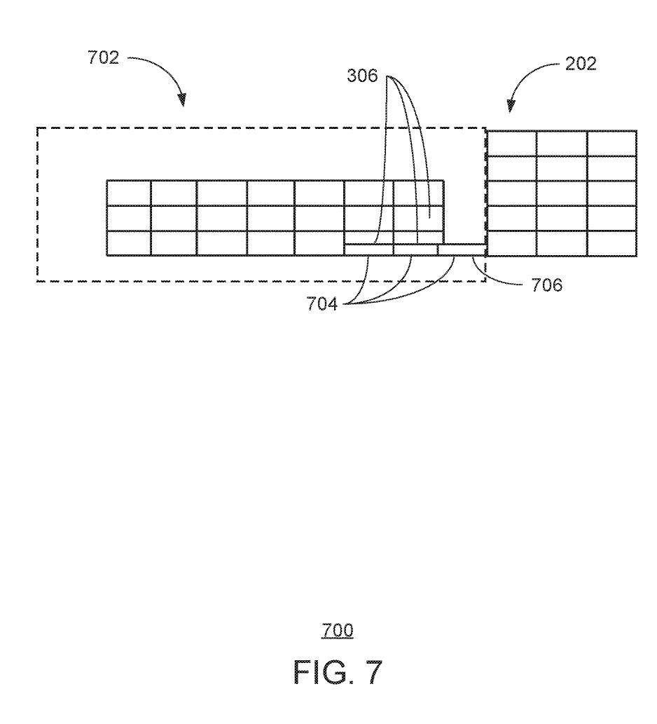

FIG. 7 shows a cross section view of an example brim including a half height perimeter. The example brim is referred to generally by the reference number 702 and includes a number of half height layers 704 used in the additional brim extension 306 having a height of three layers and the perimeter layer 706 of the brim 702. A 3D object 202 has five layers and is coupled to the brim 702 at the half height single layer perimeter 706.

In the example of FIG. 7, the brim-to-model perimeter connection 706 is made a little weaker by having a single trace around the perimeter of the object that is thinner than the normal layer height. For example, if the normal height used for layers is 0.2 mm, then the first layer of the brim may be 0.1 mm. Thus, in some examples, the connecting part of the brim 702 may be printed at half the normal height, and the rest of the brim 702 may be printed at the full height. By having just a single line around the perimeter of the object printed at half height can make the connection weaker than the 3d object or the rest of the brim 702, and thus easier to tear off. Therefore, making the first perimeter 706 of the brim 702 thinner even if there are no perforations can make the brim 702 easier to tear away from the 3d object 202. Also, any imperfections can be limited to a single extrusion width. In addition, by having the additional layers 306 of the brim slightly overlap the first perimeter 706, the chances that a tear will occur at the part to brim perimeter 706 can be increased. Moreover, by having most of the brim 602 thicker than the first perimeter 204, a tear may most likely to be somewhere in or connected to the first brim perimeter 204. In some examples, the tear may be in the first brim perimeter 204 even if there are no perforations.

It is to be understood that the block diagram of FIG. 7 is not intended to indicate that the perforated brim 702 is to include all of the components shown in FIG. 7. Rather, the perforated brim 702 can include fewer or additional components not illustrated in FIG. 7 (e.g., additional layers, brims, etc.). Furthermore, although a reduced height of half the normal height is used, any other reduced height size may be used as appropriate.

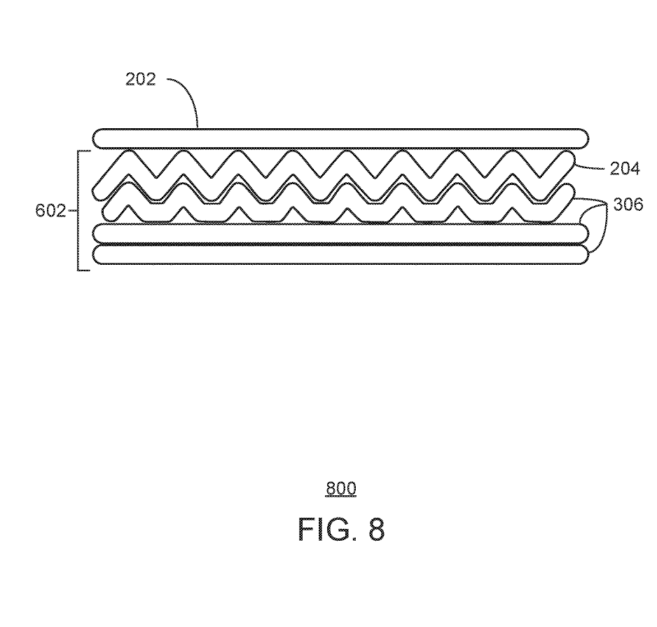

FIG. 8 shows a close-up top down view of an example first layer of a perforated brim coupled to the first layer of a 3D object. The example first layer is generally referenced by the reference number 800. The first layer 800 can be printed using the 3D printer 100 above.

In the example of FIG. 8, a first layer of a perforated brim 204 with extension material 306, together referenced by 602, is shown coupled to a first layer 202 of a 3D object. The extension material 306 may provide additional hold-down strength for the first layer 202 of the 3D object and also may result in an overall stronger brim 602.

It is to be understood that the block diagram of FIG. 8 is not intended to indicate that the first layer 800 is to include all of the components shown in FIG. 8. Rather, the first layer 800 can include fewer or additional components not illustrated in FIG. 800 (e.g., additional perforations, extension material, etc.).

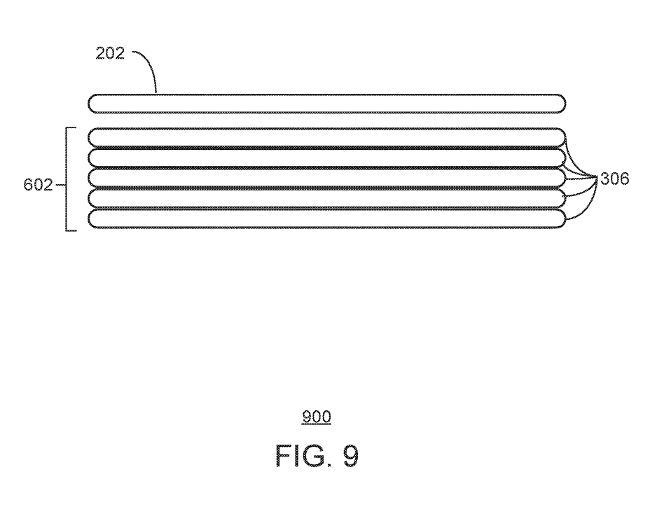

FIG. 9 shows a close-up top down view of an example second layer of a perforated brim and a second layer of a coupled 3D object. The example second layer is generally referenced by the reference number 900. The second layer 900 can be printed using the 3D printer 100 above. For example, the second layer may be printed onto the first layer of FIG. 8 above.

In the example of FIG. 9, a second layer of the perforated brim 602 includes additional extension material 306. As seen in FIG. 9, the second layer of extension material 306 is not coupled to the second layer of the 3D object 202. Thus, hold-down support may be provided by the coupling of the first layer of the brim 602 as described above, while the additional extension material 306 may provide additional strength for the brim 602. The example, the extension material 306 of the second layer may prevent unwanted tears and ensure that the brim 602 tears at the perforated brim 204 at the first layer discussed in FIG. 8.

It is to be understood that the block diagram of FIG. 9 is not intended to indicate that the second layer 900 is to include all of the components shown in FIG. 9. Rather, the second layer 900 can include fewer or additional components not illustrated in FIG. 9 (e.g., additional perforations, extension material, etc.).

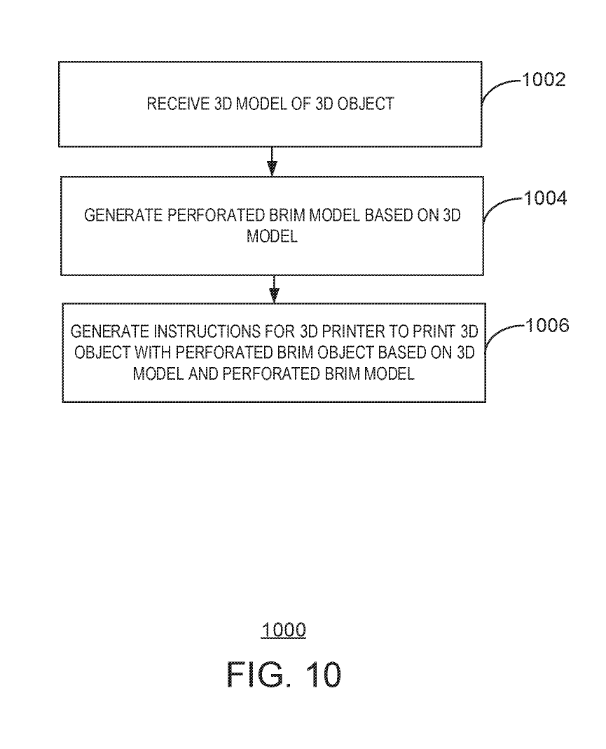

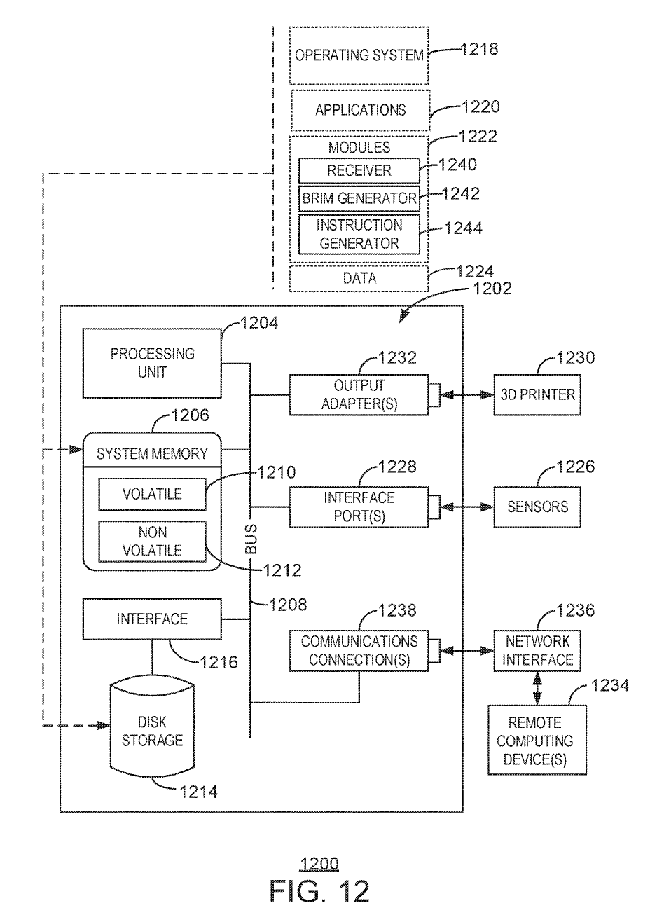

FIG. 10 shows a process flow diagram of an example method for printing 3D objects coupled to a perforated brim. The method 1000 can be implemented with any suitable computing device, such as the 3D printer 100 of FIG. 1 above or the computer 1202 of FIG. 12 below.

At block 1002, the computing device receives a 3D model of a 3D object. For example, the 3D model may be a 3D mesh model, or any model suitable for 3D printing.

At block 1004, the computing device generates a perforated brim model based on the 3D model. For example, the perforated brim model may include a perforation pattern disposed on an inner perimeter of a first brim layer of the perforated brim model. In some examples, the perforation pattern can be configured to be in intermittent contact with an outer perimeter of the 3D model based on the determined brim contact ratio. In some examples, the computing device may determine a brim contact ratio based on a distance from a center of a first layer to the outer perimeter of the first layer of the 3D model. For example, the computing device may calculate a distance from the center of a first layer to the outer perimeter of the first layer of the 3D model. In some examples, the computing device may determine the brim contact ratio based on a printing material to be used. For example, the computing device may detect a printing material to be used to print the 3D object. In some examples, the computing device may calculate a brim contact ratio based on the calculated distance, or the detected printing material, or both. In some examples, the computing device may configure the perforation pattern to be in intermittent contact with the outer perimeter of the 3D model based on the determined brim contact ratio. In some examples, the computing device may generate a perforated brim model with a second brim layer disposed on top of and across the perforation pattern of the first brim layer, the second brim layer having no contact with the outer perimeter of the 3D model. For example, the second brim layer of the perforated brim may not be attached to the 3D model. For example, the brim may contact the 3D object only at the first layer so as to have as little contact material as possible. Accordingly, the second layer may have a brim contact ratio equal to a minimal value such as 0. In some examples, the second layer may have a brim contact ratio greater than the minimal value to provide additional strength. For example, the perforated brim may be generated to couple to any suitable layer of the 3D object. In some examples, the perforated brim may couple to the 3D object at various layers to provide support. For example, for some additional hold-down strength, some contact may be provided on the second layer, such as every other triangle touching. In some examples, another zipper may be provided up some predetermined number of layers. For example, a zipper may be provided every 10 layers. In some examples, the additional layers may have less contact than the first layer, thus making it easier for the perforated brim to break away, but still strong enough to hold the 3D object down to the platform. In some examples, the computing device may generate a brim with a brim contact ratio based on a printing material to be used. For example, weaker printing materials may receive a higher brim contact ratio and stronger printing materials may receive a lower brim contact ratio. In some examples, the computing device may generate the perforated brim with a brim extension layer on an outer portion of the perforated brim to strengthen the perforated brim. In some examples, the computing device may generate a perforated brim model with a brim extension layer disposed on an outer portion of the perforated brim. In some examples, the computing device can generate a perforated brim model including additional perforated brims to hold different sides of the 3D object in place. The additional perforated brims include different and independent brim contact ratios. For example, the computing device may generate the perforated brim model with multiple perforated brims positioned around and in intermittent contact with the outer perimeter of the 3D model, each of the multiple perforated brims having an independent brim contact ratio. In some examples, the computing device can generate a perforated brim model with a perforation pattern based on a saw-tooth pattern. In some examples, the computing device can generate perforated brim model with a perforation pattern based on a flattened zipper pattern.

At block 1006, the computing device generates instructions for a 3D printer to print a 3D object with a perforated brim object based on the 3D model and the perforated brim model. For example, the instructions may include a perforation pattern coupled to an outer perimeter of a first layer of the 3D object. In some examples, the computing device can generate instructions for printing individual layers of the brim by determining a brim contact ratio as discussed in greater length with respect to FIG. 9 below. For example, the brim contact ratio may be based on a distance from a center to the outer perimeter of the first layer of the 3D object. In some examples, the computing device may generate instructions for printing the brim with the perforation pattern that implements the determined brim contact ratio. In some examples, the computing device can generate instructions for printing individual layers of the brim including instructions for printing the brim with a second layer on top of and across the perforation pattern of the first layer. For example, the second layer having no contact with the perimeter of the 3D object. In some examples, the computing device can generate instructions for printing individual layers of the brim further by determining a brim contact ratio for the perforated brim based on a printing material to be used and generating instructions for printing the brim with the perforation pattern that implements the determined brim contact ratio. In some examples, the computing device can generate instructions for printing individual layers of the brim including instructions for printing the perforated brim with a brim extension layer on an outer portion of the perforated brim to strengthen the perforated brim.

In some examples, the computing device may thus cause a 3D printer to print the 3D object and the perforated brim object based on the generated instructions. For example, the perforated brim may be generated to be coupled to an outer edge of a perimeter of a first layer of the 3D object. In some examples, the perforated brim may be attached to the 3D object using a pattern with a brim contact ratio that is below a threshold value. For example, the perforated brim may attach to any amount of the edge or perimeter of the 3D object based on the pattern. In some embodiments, the pattern may be a saw-tooth pattern or a flattened zipper pattern, among other suitable patterns. In some examples, the computing device may also print a skirt before printing the perforated brim onto the platform to ensure steady flow of the printing material. In some examples, a number of perforated brims may be printed onto the platform to hold different sides of the 3D object in place. For example, the number of perforated brims may have different brim contact ratios.

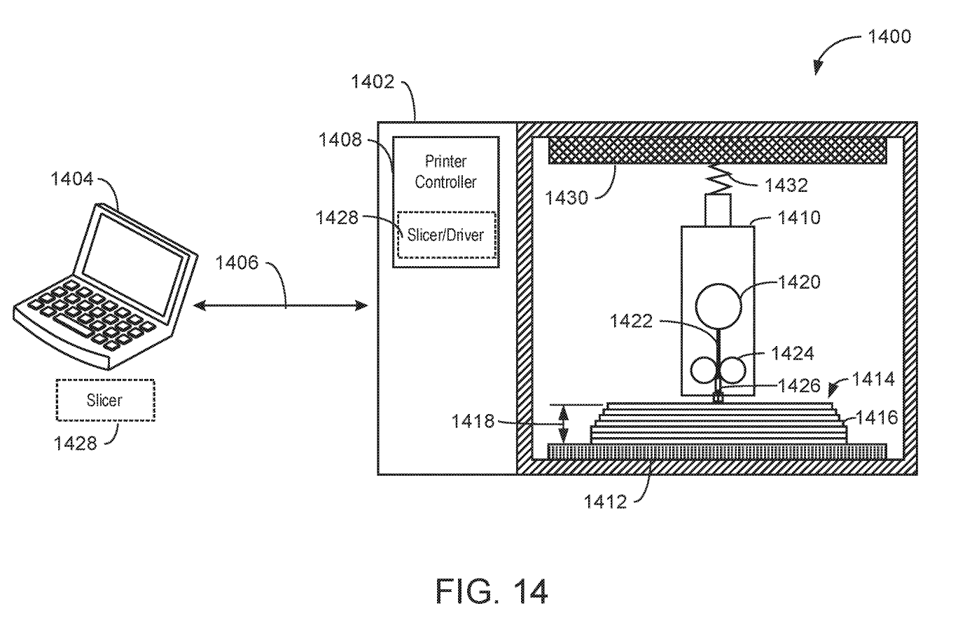

This process flow diagram is not intended to indicate that the blocks of the method 1000 are to be executed in any particular order, or that all of the blocks are to be included in every case. Further, any number of additional blocks not shown may be included within the method 1000, depending on the details of the specific implementation. Furthermore, in some examples, steps 1002 and 1004 may be implemented using the computing device 1002 of FIG. 1- below, the 3D printer 100 of FIG. 1 above, or any combination thereof. In some examples, the method may be implemented using the slicer 1428 of the computing device 1404, or the slicer 1428 of the printer controller 1408 of FIG. 14 below, or any combination thereof.

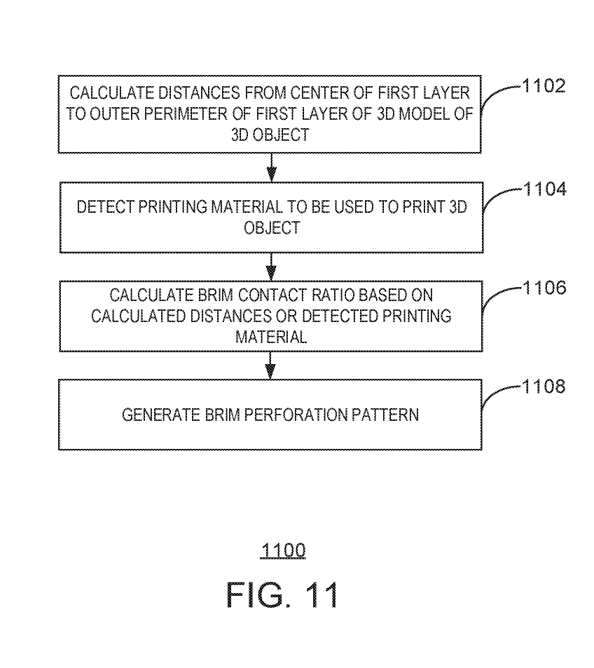

FIG. 11 shows a process flow diagram of an example method for generating a perforated brim model for a 3D model. The method 1100 can be implemented with any suitable computing device, such as the 3D printer 100 of FIG. 1 above or the computer 1202 of FIG. 12 below.

At block 1102, the 3D printer calculates distances from a center of the first layer to an outer perimeter of the first layer of a 3D model of a 3D object. The perforated brim is to be printed around the 3D object, in intermittent contact with the outer perimeter of the 3D object. For example, the distance from the center to an outer perimeter of the first layer of the 3D object may be used to calculate a percentage of brim or portion of brim inner perimeter that will be in contact with the with the outer perimeter of the 3D object.

At block 1104, the 3D printer detects a printing material to be used to print the 3D object. For example, the 3D printer may receive a type of printing material to be used at a user interface. The user interface may have a list of possible printing materials to select. Each type of printing material may have an associated strength value.

At block 1106, the 3D printer calculates a brim contact ratio based on the calculated distances, or the printing material, or both. In some examples, the calculated distances may be used to calculate the brim contact ratio at each corresponding point of the perforated brim. For example, a smaller distance may result in a smaller brim contact ratio at a particular point of the perforated brim. By contrast, a larger distance may result in a larger brim contact ratio at a particular point of a perforated brim. In some examples, a single brim contact ratio may be used based on the larger distance of all the calculated distances. In some examples, the strength of the printing material to be used may also be taken into account. For example, a higher strength may result in a lower brim contact ratio. A lower strength may result in a higher brim contact ratio. For example, a saw-toothed pattern may be used for portions of the perforated brim with a lower brim contact ratio. In some examples, a flattened zipper pattern may be used for portions of the perforated brim with a higher brim contact ratio.

At block 1108, the 3D printer generates a brim perforation pattern. For example, the brim perforation pattern may be disposed on an inner portion of the perforated brim and may intermittently contact the perimeter of the 3D model. In some examples, the perforation pattern may be based on the calculated brim contact ratio.

This process flow diagram is not intended to indicate that the blocks of the method 1100 are to be executed in any particular order, or that all of the blocks are to be included in every case. Further, any number of additional blocks not shown may be included within the method 1100, depending on the details of the specific implementation. Furthermore, in some examples, the method 1100 may be implemented using the computing device 1202 of FIG. 12- below, the 3D printer 100 of FIG. 1 above, or any combination thereof. In some examples, the method may be implemented using the slicer 1428 of the computing device 1404 or the slicer 1428 of the printer controller 1408 of FIG. 14 below, or any combination thereof.

FIG. 12 is intended to provide a brief, general description of a computing environment in which the various techniques described herein may be implemented. For example, a method and system for scanning a 3D object and processing a 3D model to be used for fabricating 3D objects can be implemented in such a computing environment. While the claimed subject matter has been described above in the general context of computer-executable instructions of a computer program that runs on a local computer or remote computer, the claimed subject matter also may be implemented in combination with other program modules. Generally, program modules include routines, programs, components, data structures, or the like that perform particular tasks or implement particular abstract data types.

FIG. 12 is a block diagram of an example operating environment configured for implementing various aspects of the techniques described herein. The example operating environment 1200 includes a computer 1202. The computer 1202 includes a processing unit 1204, a system memory 1206, and a system bus 1208.

The system bus 1208 couples system components including, but not limited to, the system memory 1206 to the processing unit 1204. The processing unit 1204 can be any of various available processors. Dual microprocessors and other multiprocessor architectures also can be employed as the processing unit 1204.

The system bus 1208 can be any of several types of bus structure, including the memory bus or memory controller, a peripheral bus or external bus, and a local bus using any variety of available bus architectures known to those of ordinary skill in the art. The system memory 1206 includes computer-readable storage media that includes volatile memory 1210 and nonvolatile memory 1212.

The basic input/output system (BIOS), containing the basic routines to transfer information between elements within the computer 1202, such as during start-up, is stored in nonvolatile memory 1212. By way of illustration, and not limitation, nonvolatile memory 1212 can include read-only memory (ROM), programmable ROM (PROM), electrically programmable ROM (EPROM), electrically erasable programmable ROM (EEPROM), or flash memory.

Volatile memory 1210 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 1202 also includes other computer-readable media, such as removable/non-removable, volatile/non-volatile computer storage media. FIG. 12 shows, for example a disk storage 1214. Disk storage 1214 includes, but is not limited to, devices like a magnetic disk drive, floppy disk drive, tape drive, Jaz drive, Zip drive, LS-210 drive, flash memory card, or memory stick.

In addition, disk storage 1214 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1214 to the system bus 1208, a removable or non-removable interface is typically used such as interface 1216.

It is to be appreciated that FIG. 12 describes software that acts as an intermediary between users and the basic computer resources described in the suitable operating environment 1200. Such software includes an operating system 1218. Operating system 1218, which can be stored on disk storage 1214, acts to control and allocate resources of the computer 1202.

System applications 1220 take advantage of the management of resources by operating system 1218 through program modules 1222 and program data 1224 stored either in system memory 1206 or on disk storage 1214. It is to be appreciated that the claimed subject matter can be implemented with various operating systems or combinations of operating systems.

A user can input scan information into the computer 1202 through sensors 1226. Sensors 1226 can include, but are not limited to, a depth sensor, camera, scanner, a digital camera, a digital video camera, a web camera, and the like. For example, the sensors 1226 can be those found inside a depth camera such as the Kinect® sensor. The sensors 1226 connect to the processing unit 1204 through the system bus 1208 via interface ports 1228. Interface ports 1228 include, for example, a serial port, a parallel port, a game port, and a universal serial bus (USB).

Three-dimensional (3D) printer 1230 can use some of the same type of ports as sensors 1226. Thus, for example, a USB port may be used to provide input to the computer 1202, and to output information from computer 1202 to a 3D printer 1230.

Output adapter 1232 is provided to illustrate that 3D printer 1230 may be accessible via adapters. The output adapters 1232 include any cards that can provide a means of connection between the 3D printer 1230 and the system bus 1208. It can be noted that other devices and systems of devices can provide both input and output capabilities such as remote computers 1234.

The computer 1202 can be a server hosting various software applications in a networked environment using logical connections to one or more remote computers, such as remote computers 1234. The remote computers 1234 may be client systems configured with web browsers, PC applications, mobile phone applications, and the like. The remote computers 1234 can be a personal computer, a server, a router, a network PC, a workstation, a microprocessor based appliance, a mobile phone, a peer device or other common network node and the like, and typically includes many or all of the elements described relative to the computer 1202.

Remote computers 1234 can be logically connected to the computer 1202 through a network interface 1236 and then connected via a communication connection 1238, which may be wireless. Network interface 1236 encompasses wireless communication networks such as local-volume networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 1238 refers to the hardware/software employed to connect the network interface 1236 to the bus 1208. While communication connection 1238 is shown for illustrative clarity inside computer 1202, it can also be external to the computer 1202. The hardware/software for connection to the network interface 1236 may include, for exemplary purposes, internal and external technologies such as, mobile phone switches, modems including regular telephone grade modems, cable modems and DSL modems, ISDN adapters, and Ethernet cards.

An example processing unit 1204 for the server may be a computing cluster. The disk storage 1214 may comprise an enterprise data storage system, for example, holding thousands of impressions. The computer 1202 can be configured to instruct a printer to fabricate a 3D object. The data 1224 may include one or more 3D models, which may be obtained or constructed from information obtain from sensors 1226, for example. In some examples, the 3D model is a mesh model.

One or more of applications 1220 may be configured to enable a user to scan an object and generate and customize a 3D model for later fabrication as an object. The user may not generate the 3D model as the application 1220 may automate this process or adapt a 3D model ultimately obtained from sensors 1226 or remote computing device 1234 via a network interface 1236.

In addition, or alternatively, one or more modules 1222 can be configured to perform printing of 3D objects. A receiver module 1240 can receive a 3D model of a 3D object to be printed. A brim generator module 1242 can generate a perforated brim model of a perforated brim object to be printed based on the 3D model. For example, the perforated brim model may include a perforation pattern. In some examples, the perforation pattern can be disposed on an inner portion of a layer of the perforated brim model. For example, the perforation pattern of the perforated brim object can be coupled to a perimeter of a first layer of the 3D object. For example, the perforated brim may have a saw-tooth or a flattened zipper pattern as described above. In some examples, the perforated brim model may include a brim extension material to hold the 3D object to the build plate. For example, the brim extension may be an outer portion of the perforated brim that is thicker than an inner portion of the perforated brim. In some examples, the perforated brim model may have a brim contact ratio with the perimeter of the 3D object based on a distance from the center of the 3D object to the perimeter of the 3D object. For example, the perimeter may be the perimeter of a first layer of the 3D object. In some examples, the perforated brim model may have a brim contact ratio with a perimeter of the 3D object based on a printing material to be used. In some examples, the perforated brim model may include a second layer of brim extension material that overlaps a first layer of the perforated brim. For example, the second layer of brim extension material may not contact the 3D object. An instruction generator module 1244 can cause a 3D printer to print the perforated brim object and the 3D object, wherein the perforation pattern of the perforated brim object is to be coupled to the 3D object. For example, the 3D printer may be the 3D printer 1230. In some examples, the perforation pattern may be a saw-tooth pattern.

In some examples, some or all of the processes performed for generating the mesh can be performed in a cloud service and reloaded on the client computer of the user. For example, some or all of the applications 1220 or the modules 1222 described for perforated brim generation can be executed in a cloud service and can receive input from a user through a client computer 1202. Thus, the computations involved in computing the 3D model can be performed on a cloud computing system. These computations can include calculating a brim contact ratio based on distance from a center of a 3D object or the type of material to be used in printing. In other examples, a computer can receive a user request for the printing of a 3D object and forward the request to a cloud service. The cloud service can then retrieve a perforated brim model from a remote computer and return printing instructions to a 3D printer 1230. The printer may be local to the user or remote and the 3D object later retrieved by the user. In other examples, the brim generator module 1242 may generate a model of the perforated brim locally based on techniques herein described and submit the generated model to a cloud service, which processes the 3D model based on techniques herein described, and returns printing instructions to a printer. In some examples, the brim generator module 1242 may generate the perforated brim locally based on the techniques described herein and the printer module 1244 can print the perforated brim on a locally attached 3D printer 1230.

It is to be understood that the block diagram of FIG. 12 is not intended to indicate that the computing system 1200 is to include all of the components shown in FIG. 12. Rather, the computing system 1200 can include fewer or additional components not illustrated in FIG. 12 (e.g., additional applications, additional modules, additional memory devices, additional network interfaces, etc.). Furthermore, any of the functionalities of the receiver module 1240, the brim generator module 1242, and the instruction generator module 1244, can be partially, or entirely, implemented in hardware and/or in a processor. For example, the functionality can be implemented with an application specific integrated circuit, in logic implemented in the processor, or in any other device. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), and Complex Programmable Logic Devices (CPLDs), etc.

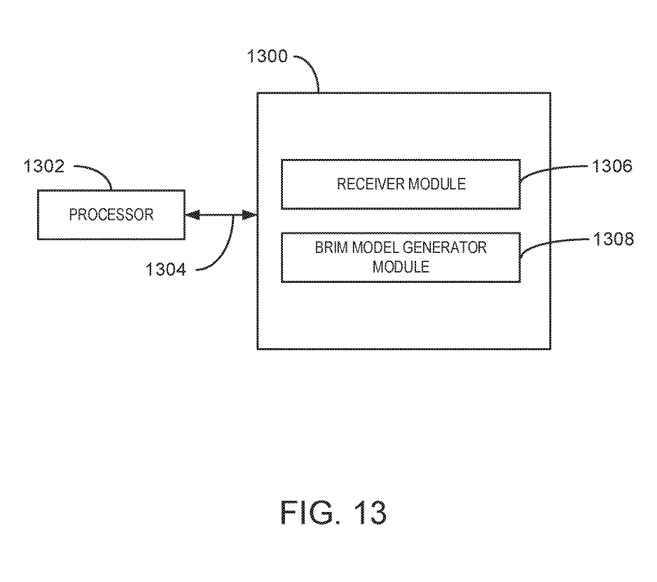

FIG. 13 is a block diagram showing a tangible, computer-readable storage medium that can be used to generate a perforated brim model based on a three-dimensional (3D) model of a 3D object. The tangible, computer-readable storage media 1300 can be accessed by a processor 1302 over a computer bus 1304. Furthermore, the tangible, computer-readable storage media 1300 can include code to direct the processor 1302 to perform the current methods. For example, methods of FIGS. 10 and 11 can be partially performed by the processor 1302.

The various software components discussed herein can be stored on the tangible, computer-readable storage media 1300, as indicated in FIG. 13. For example, the tangible computer-readable storage media 1300 can include a receiver module 1306 and a brim model generator module 1308. In some implementations, the receiver module 1306 includes code to receive a 3D model of a 3D object to be printed. The brim model generator module 1308 includes code to generate a perforated brim model of a perforated brim object based on the 3D model. For example, a first brim layer of the perforated brim model may include a perforation pattern. The perforated brim object can be printed coupled to the 3D object.

In some examples, the brim model generator module 1308 may include code to generate the perforated brim model in intermittent contact with a perimeter of the 3D model. For example, a brim contact ratio can be based on a distance from a center to the perimeter of the 3D model. In some examples, the brim model generator module 1308 may include code to generate the perforated brim model with a brim contact ratio of the perforated brim based on a printing material to be used. In some examples, the brim model generator module 1308 may include code to generate the perforated brim model with a second brim layer of brim extension material that overlaps the first layer of the perforated brim. For example, the second layer of brim extension material may not contact the 3D object. In some examples, the brim model generator module 1308 may include code to generate the perforated brim model with additional brim extension material. For example, the additional brim extension material may be included in the perforated brim to hold the 3D object to the base plate.

It is to be understood that any number of additional software components not shown in FIG. 13 can be included within the tangible, computer-readable storage media 1300, depending on the specific application. Although the subject matter has been described in language specific to structural features and/or methods, it is to be understood that the subject matter defined in the appended claims is not necessarily limited to the specific structural features or methods described above. Rather, the specific structural features and methods described above are disclosed as example forms of implementing the claims.

FIG. 14 shows an example system 1400 including a computing device 1404 in communication with a three-dimensional (3D) printer 1402 capable of or configured to print a 3D object 1414 with a perforated brim. The computing device 1404 may include any of a laptop, a desktop or personal computer (PC), mobile devices such as smart phones, tablets, etc., networked devices, cloud computing resources, or combinations thereof. The computing device 1404 may communicate with 3D printer 1402 via a wired connection or any of a variety of wireless connections 1406, as are known to one of skill in the art. The 3D printer 1402 may have or be associated with any of a variety of transceivers, modems, NICs, etc., typically associated with the printer controller 1408, to communicate with computing device 1404 via wired and/or wireless connection 1406. In general, the computing device 1404 may execute or access (via a network or via the cloud), one or more software programs or applications that take 3D object data and translate the data into instructions executable by the printer controller 1408 controlling the 3D printer 1402 (e.g., G-code) to enable 3D printer 1402 to form 3D object 1414 by extruding material onto the base 1412 in multiple (e.g., separately) configurable layers 1416. For reference purposes, and as used throughout, the software application, which may in some cases include a CAD component, a CAM component, 3D image capture and translation functions, and so on, may be referred to as slicer or driver 1428. In most circumstances, the slicer 1428 will be associated with the computing device 1404. However, it is contemplated herein that the slicer 1428 may be in whole or in part associated with an individual 3D printer 1402 that might, but not necessarily be a function of or within the printer controller 1408, without departing from the techniques described herein.

The 3D printer 1402 may include one or more extruder assemblies 1410 positioned over an object base or bed 1412. The extruder assembly 1410 may be moved in at least the vertical direction (z axis) by movement means 1432, which may include one or more stepper or servo motors, as is generally known in the art. The movement means 1432 may also move the extruder assembly 1410 in the horizontal plane (x or y axis), such as along the upper plate 1430 relative to the base 1412. Other 3D printer 1402 designs fix the extruder 1410 in the z-axis and move it in the x-axis and y-axis while moving the bed 1412 in the z-axis. Yet other designs move the extruder 1410 in the z-axis and x-axis while moving the bed 1412 in the y-axis. Still other designs operate using a polar coordinate system to move the extruder 1410 over a stationary bed 1412. The techniques described herein are applicable to these and other variations of 3D printer configurations (such as Delta Parallel Kinematic printers). In some aspects, the extruder assembly 1410 may include or house one or more filaments 1422, for example wound/stored in spool 1420. In other cases, the filament 1422 may be stored or housed in other portions of the 3D printer 1402 or completely external to the 3D printer 1402. The extruder assembly 1410 may also include opposing rollers 1424 that drive filament 1422 into a heated nozzle 1426, at a specified rate, whereby the filament is melted and extruded onto the most recently deposited layer of layers 1416 previously deposited onto base 1412. The extruder assembly 1410 may include means, such as one or more motors, other drive mechanisms, etc., for controlling the rate at which filament 1422 is fed into the heated nozzle 1426 by rollers 1424 and extruded from nozzle 1426, thus controlling the height of each layer of layers 1416.

According to the techniques described herein, the extruder assembly 1410 may be controlled to receive a 3D model of a 3D object to be printed. In one example, the slicer 1428 of the printer controller 1408 may generate a perforated brim model of a perforated brim object to be printed based on the 3D model. In some examples, a slicer 1428 on the computing device 1404 may generate the perforated brim model based on the 3D model. In some examples, the printer controller 1408 may then receive the generated perforated brim model from the slicer 1428 of the computing device 1404. In some examples, the printer controller 1408 may cause the 3D printer to print the perforated brim and the 3D object. For example, the perforated brim may be printed using the perforated brim model and the 3D object may be printed using the 3D model of the 3D object. In yet some examples, the computing device 1404 and/or slicer 1428 may provide a user interface for enabling a user to manually configure or set one or more parameters for generating the 3D object 1414 with a perforated brim. In some examples, the perforated brim may include a layer including an inner pattern of perforations to be coupled to an outer edge of a perimeter of a first layer of the 3D object. In some examples, the perforated brim may include an outer portion of brim extension material that is thicker than an inner portion of the perforated brim. In some examples, the perforated brim model may include a brim contact ratio with the perimeter of the 3D object based on a distance from a center of the 3D object to the perimeter of the 3D object. In some examples, the perforated brim model may have a brim contact ratio with a perimeter of the 3D object based on a printing material to be used. In some examples, the perforated brim model may include a second layer of brim extension material that overlaps a first layer of the perforated brim model. The brim extension material may not contact the 3D object. In some examples, the perforation pattern may be a saw-tooth pattern, among other suitable patterns. For example, the perforation pattern may be based on the brim contact ratio.

### EXAMPLE 1

This example provides for a system for printing three-dimensional (3D) objects. The system includes a computer processor and a computer memory including instructions that cause the computer processor to receive a 3D model of a 3D object to be printed. The computer memory also includes instructions that cause the computer processor to generate a perforated brim model of a perforated brim object to be printed based on the 3D model. The perforated brim model includes a perforation pattern. The system also includes instructions that cause the computer processor to cause a 3D printer to print the perforated brim object and the 3D object. The perforation pattern of the perforated brim object is to be coupled to the 3D object. Alternatively, or in addition, the perforation pattern is disposed on an inner portion of a layer of the perforated brim model. Alternatively, or in addition, the perforation pattern of the perforated brim object is to be coupled to a perimeter of a first layer of the 3D object. Alternatively, or in addition, the perforated brim model includes an outer portion of brim extension material that is thicker than an inner portion of the perforated brim model. Alternatively, or in addition, the perforated brim model includes a brim contact ratio with a perimeter of the 3D object based on a distance from a center of the 3D object to the perimeter. Alternatively, or in addition, the perforated brim model includes a brim contact ratio with a perimeter of the 3D object based on a printing material to be used. Alternatively, or in addition, the perforated brim model includes a second layer of brim extension material that overlaps a first layer of the perforated brim model. The second layer of brim extension material may not contact the 3D model. Alternatively, or in addition, the perforation pattern may be a saw-tooth pattern.

### EXAMPLE 2

This example provides for a method for printing 3D objects coupled to a perforated brim. The method can include receiving a 3D model of a 3D object. The method can also include generating a perforated brim model based on the 3D model. The perforated brim model can include a perforation pattern disposed on an inner perimeter of a first brim layer of the perforated brim model. The perforation pattern can be configured to be in intermittent contact with an outer perimeter of the 3D model. The method can also include generating instructions for a 3D printer to print the 3D object with a perforated brim object based on the 3D model and the perforated brim model. Alternatively, or in addition, generating the perforated brim model further includes determining a brim contact ratio based on a distance from a center of a first layer to the outer perimeter of the first layer of the 3D model, and configuring the perforation pattern to be in intermittent contact with the outer perimeter of the 3D model based on the determined brim contact ratio. Alternatively, or in addition, generating the perforated brim model further includes a second brim layer disposed on top of and across the perforation pattern of the first brim layer, the second brim layer having no contact with the outer perimeter of the 3D model. Alternatively, or in addition, generating the perforated brim model further includes determining a brim contact ratio based on a printing material to be used, and configuring the perforation pattern to be in intermittent contact with the outer perimeter of the 3D model based on the determined brim contact ratio. Alternatively, or in addition, generating the perforated brim model further includes a brim extension layer disposed on an outer portion of the perforated brim. Alternatively, or in addition, generating the perforated brim model further includes multiple perforated brims positioned around and in intermittent contact with the outer perimeter of the 3D model, each of the multiple perforated brims having an independent brim contact ratio. Alternatively, or in addition, generating the perforated brim model further includes calculating a distance from a center of a first layer to the outer perimeter of the first layer of the 3D model; detecting a printing material to be used to print the 3D object; and calculating a brim contact ratio based on the calculated distance or the detected printing material. Alternatively, or in addition, generating the perforated brim model further includes the perforation pattern being based on a saw-tooth pattern.

### EXAMPLE 3

This example provides for one or more computer-readable storage medium for storing computer readable instructions that, when executed by one or more processing devices, instruct the generation of a perforated brim model based on a three-dimensional (3D) model of a 3D object. The computer-readable medium includes instructions to receive a 3D model of a 3D object to be printed. The computer-readable medium also include instructions to generate a perforated brim model of a perforated brim object based on the 3D model. A first brim layer of the perforated brim model can include a perforation pattern, and the perforated brim model may be printed coupled to the 3D object. Alternatively, or in addition, the computer-readable medium also include instructions to generate the perforated brim model in intermittent contact with a perimeter of the 3D model. Alternatively, or in addition, the brim contact ratio is based on a distance from a center to the perimeter of the 3D model. Alternatively, or in addition, the computer-readable medium also include instructions to generate the perforated brim model in intermittent contact with a perimeter of the 3D model, wherein the brim contact ratio is based on a printing material to be used. Alternatively, or in addition, the computer-readable medium also include instructions to generate the perforated brim model with a second brim layer of brim extension material that overlaps the first brim layer of the perforated brim model. Alternatively, or in addition, the second brim layer of brim extension material does not contact the 3D model. Alternatively, or in addition, the computer-readable medium also include instructions to generate the perforated brim model with additional brim extension material.

### EXAMPLE 4

This example provides for a system for printing three-dimensional (3D) objects. The system includes means for receiving a 3D model of a 3D object to be printed. The system also includes means for generating a perforated brim model of a perforated brim object to be printed based on the 3D model. The perforated brim model includes a perforation pattern. The system also includes means for causing a 3D printer to print the perforated brim object and the 3D object. The perforation pattern of the perforated brim object is to be coupled to the 3D object. Alternatively, or in addition, the perforation pattern is disposed on an inner portion of a layer of the perforated brim model. Alternatively, or in addition, the perforation pattern of the perforated brim object is to be coupled to a perimeter of a first layer of the 3D object. Alternatively, or in addition, the perforated brim model includes an outer portion of brim extension material that is thicker than an inner portion of the perforated brim model. Alternatively, or in addition, the perforated brim model includes a brim contact ratio with a perimeter of the 3D object based on a distance from a center of the 3D object to the perimeter. Alternatively, or in addition, the perforated brim model a brim contact ratio with a perimeter of the 3D object based on a printing material to be used. Alternatively, or in addition, the perforated brim model includes a second layer of brim extension material that overlaps a first layer of the perforated brim. The second layer of brim extension material may not contact the 3D object. Alternatively, or in addition, the perforation pattern may be a saw-tooth pattern.

### EXAMPLE 5

This example provides for a method for generating a perforated brim model for a 3D model. The method can include calculating a distance from a center of a first layer to an outer perimeter of the first layer of a 3D model of a 3D object. The method can also include detecting a printing material to be used to print the 3D object. The method can also include calculating a brim contact ratio based on the calculated distance, or the detected printing material. The method can further include generating a brim perforation pattern. The brim perforation pattern may be disposed on an inner portion of the perforated brim model, and may intermittently contact the outer perimeter of the 3D model based on the calculated brim contact ratio.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for printing three-dimensional (3D) objects, comprising:
a computer processor; and
a computer memory, comprising instructions that cause the computer processor to:
receive a 3D model of a 3D object to be printed;
generate a perforated brim model of a perforated brim object to be printed based on the 3D model, the perforated brim model comprising a perforation pattern; and
cause a 3D printer to print the perforated brim object and the 3D object, wherein the perforation pattern of the perforated brim object is to be coupled to the 3D object.

2. The system of claim 1, wherein the perforation pattern is disposed on an inner portion of a layer of the perforated brim model, the perforation pattern of the perforated brim object is to be coupled to a perimeter of a first layer of the 3D object.

3. The system of claim 1, wherein the perforated brim model comprises an outer portion of brim extension material that is thicker than an inner portion of the perforated brim model.

4. The system of claim 1, wherein the perforated brim model comprises a brim contact ratio with a perimeter of the 3D object based on a distance from a center of the 3D object to the perimeter.

5. The system of claim 1, wherein the perforated brim model comprises a brim contact ratio with a perimeter of the 3D object based on a printing material to be used.

6. The system of claim 1, wherein the perforated brim model comprises a second layer of brim extension material that overlaps a first layer of the perforated brim model, wherein the second layer of brim extension material does not contact the 3D model.

7. The system of claim 1, wherein the perforation pattern comprises a saw-tooth pattern.

8. A method for printing three-dimensional (3D) objects coupled to a perforated brim, the method comprising:
receiving a 3D model of a 3D object;
generating a perforated brim model based on the 3D model,
the perforated brim model comprising a perforation pattern disposed on an inner perimeter of a first brim layer of the perforated brim model,
wherein the perforation pattern is configured to be in intermittent contact with an outer perimeter of the 3D model; and
generating instructions for a 3D printer to print the 3D object with a perforated brim object based on the 3D model and the perforated brim model.

9. The method of claim 8, wherein generating the perforated brim model further comprises determining a brim contact ratio based on a distance from a center of a first layer to the outer perimeter of the first layer of the 3D model, and configuring the perforation pattern to be in intermittent contact with the outer perimeter of the 3D model based on the determined brim contact ratio.

10. The method of claim 8, wherein generating the perforated brim model further comprises a second brim layer disposed on top of and across the perforation pattern of the first brim layer, the second brim layer having no contact with the outer perimeter of the 3D model.

11. The method of claim 8, wherein generating the perforated brim model further comprises determining a brim contact ratio based on a printing material to be used, and configuring the perforation pattern to be in intermittent contact with the outer perimeter of the 3D model based on the determined brim contact ratio.

12. The method of claim 8, wherein generating the perforated brim model further comprises a brim extension layer disposed on an outer portion of the perforated brim.

13. The method of claim 8, wherein generating the perforated brim model further comprises multiple perforated brims positioned around and in intermittent contact with the outer perimeter of the 3D model, each of the multiple perforated brims having an independent brim contact ratio.

14. The method of claim 8, wherein generating the perforated brim model further comprises:
calculating a distance from a center of a first layer to the outer perimeter of the first layer of the 3D model;
detecting a printing material to be used to print the 3D object; and
calculating a brim contact ratio based on the calculated distance, or the detected printing material.

15. The method of claim 8, wherein generating the perforated brim model further comprises the perforation pattern being based on a saw-tooth pattern.

16. One or more computer-readable memory storage devices for storing computer-readable instructions that, when executed by one or more processing devices, generate a perforated brim model based on a three-dimensional (3D) model of a 3D object, the computer-readable instructions comprising code to:
receive a 3D model of a 3D object to be printed; and
generate a perforated brim model of a perforated brim object based on the 3D model, a first brim layer of the perforated brim model comprising a perforation pattern, and the perforated brim model to be printed coupled to the 3D object.

17. The one or more computer-readable memory storage devices of claim 16, the computer-readable instructions comprising code to generate the perforated brim model in intermittent contact with a perimeter of the 3D model, wherein a brim contact ratio is based on a distance from a center to the perimeter of the 3D model.

18. The one or more computer-readable memory storage devices of claim 16, the computer-readable instructions comprising code to generate the perforated brim model in intermittent contact with a perimeter of the 3D model, wherein a brim contact ratio is based on a printing material to be used.

19. The one or more computer-readable memory storage devices of claim 16, the computer-readable instructions comprising code to generate the perforated brim model with a second brim layer of brim extension material that overlaps the first brim layer of the perforated brim model, wherein the second brim layer of brim extension material does not contact the 3D model.

20. The one or more computer-readable memory storage devices of claim 16, the computer-readable instructions comprising code to generate the perforated brim model with additional brim extension material.

21. A method for generating a perforated brim model for a 3D model, comprising:
calculating a distance from a center of a first layer to an outer perimeter of the first layer of a 3D model of a 3D object;
detecting a printing material to be used to print the 3D object;
calculating a brim contact ratio based on the calculated distance, or the detected printing material; and
generating a brim perforation pattern, wherein the brim perforation pattern is disposed on an inner portion of the perforated brim model, and intermittently contacts the outer perimeter of the 3D model based on the calculated brim contact ratio.
